(19) United States
(12) Patent Application Publication
(10) Pub. No.: US 2026/0298614 A1
(43) Pub. Date: Oct. 1, 2026

(54) COMPACT INTERFEROMETER

(71) Applicant: United Kingdom Research and Innovation, Swindon Wiltshire (GB)

(72) Inventor: Ali Hussain, Oxfordshire (GB)

(73) Assignee: United Kingdom Research and Innovation, Swindon Wiltshire (GB)

(21) Appl. No.: 19/477,626

(22) PCT Filed: Apr. 4, 2024
(86) PCT No.: PCT/EP2024/059167

§ 371 Date: Oct. 22, 2025

(30) Foreign Application Priority Data
May 11, 2023 (GB) 2306942.0

(51) Int. Cl. G01B 9/02015; G01B 9/02; G01J 3/45

(52) U.S. Cl. CPC G01B 9/02015; G01B 9/02041; G01J 3/45

(57) ABSTRACT

There is described an interferometer comprising: a beamsplitter arranged to divide an input beam into first and second beams; path differencing optics arranged to direct the first and second beams in opposite directions around a cyclic path and back to the beamsplitter, wherein the beamsplitter is arranged to divide, on return to the beamsplitter, the first and second beams each into transmitted and reflected portions; a first detector array arranged to detect a first interference pattern generated from the transmitted portion of the first beam and the reflected portion of the second beam; wherein one or more components of the path differencing optics are oriented to direct the first and second beams to be incident on the beamsplitter spatially offset, or spatially diverging, from an incidence position of the input beam on the beamsplitter; and a second detector array arranged to detect a second interference pattern generated from the reflected portion of the first beam and the transmitted portion of the second beam. A spatial offset may be out of a plane comprising the beamsplitter and path differencing optics or may be in plane.

### TECHNICAL FIELD

The present invention relates to a compact interferometer. The interferometer has no, or a limited number of, moving parts making it robust for use in hostile environments.

The interferometer has reduced light loss compared to conventional interferometers, with the recovered light allowing additional functionality to be provided. The present invention also provides a Fourier transform spectrometer comprising the interferometer.

### BACKGROUND

Fourier Transform (FT) spectroscopy is a well-known tool for the analysis of gases, liquids and solids. In FT spectroscopy, an interferometer is used to generate an interferogram which is created by interference between two beams that have travelled along optical paths with different optical path lengths. The interferogram is generated by either a moving mirror which results in an interferogram collected in the temporal domain or a static mirror which results in an interferogram collected in the spatial domain. The interference pattern generated is collected or sensed on a detector array positioned along the optical axis. Fast Fourier Transformation (FFT) of the interferogram may be used to produce an amplitude spectrum and phase information.

Most commercial FT spectrometers are based on the Michelson interferometer. The Michelson interferometer comprises a beamsplitter which divides input light and directs the two portions along separate first and second legs. At the ends of the legs are mirrors which return the two portions to the beamsplitter. At the beamsplitter the portions are combined and interfere with each other. The interfered light is collected on a detector. To produce an interferogram the length of one of the legs is changed to vary the optical path difference between the two legs. This length is changed by moving the position of one of the mirrors at the end of one of the legs. As the mirror is moved the interfered light received on the detector will change. The interferogram is collected over time on the detector as the mirror is moved.

Static Fourier transform spectrometers are also known. Such spectrometers sometimes use the Sagnac design of interferometer which generates the interferogram in the spatial domain. One example of a Sagnac-based interferometer is that described in EP 2526392 B1 by the current applicant.

FIG. 1 is a schematic diagram of a prior art interferometer 1. The interferometer 1 comprises a beamsplitter BS, a pair of curved mirrors M1 and M2, and a detector D. Input light 10 is incident on the beamsplitter BS and is divided into reflected and transmitted portions by the beamsplitter. These portions are respectively incident on curved mirrors M1 and M2. The reflected portion 31 is incident on curved mirror M1 which reflects it towards the other curved mirror M2. Curved mirror M2 reflects the portion back to the beamsplitter at 32. Similarly, the beam portion 41 transmitted through the beamsplitter BS is incident on curved mirror M2 which reflects it towards curved mirror M1. Curved mirror M1 reflects the portion back to the beamsplitter at 42. Part of the beam portion 32 is reflected again at the beamsplitter BS which directs it towards the detector D. Part of the beam portion 42 is transmitted through the beamsplitter BS to detector D. The curved mirrors converge or focus the beam portions onto the detector to generate the interference pattern. An optical path difference is provided by the reflected 31 and transmitted 41 beam portions taking slightly different routes around the mirrors, past the beamsplitter and onto the detector. The interference pattern is spread across the detector. In other words, the interferogram is generated spatially across the detector. The Sagnac design has the advantage of no moving parts making it robust.

A problem with Sagnac and Michelson based interferometers is that of significant light loss. For example, less than 50% of the input light arrives at the detector. This is partly down to the losses of optical components but also at the beamsplitter only half of the light is directed to the detector. We mentioned above in relation to FIG. 1 that for the beam portion 32 arriving at the beamsplitter only part of it is reflected to the detector. Since the beamsplitter is preferably a 50:50 beamsplitter, meaning that incident light is evenly split between reflection and transmission, only half of the beam portion 32 arriving at the beamsplitter is reflected to the detector. The other half of beam portion 32 is transmitted through the beamsplitter. The same is true for beam portion 42 arriving at the beamsplitter. Half of beam portion 42 is transmitted through the beamsplitter and the other half is reflected at the beamsplitter. The lost beam portions travel substantially in the direction that the input beam 10 arrives from. Hence, if the input beam is generated from a laser or optical cavity and this light is permitted into the laser or optical cavity it may cause instabilities. Therefore, it is desirable to both avoid the loss of the portions of light that are directed to the source and to prevent the light from being incident in a laser or optical cavity.

The loss of part of the beam results in a lower signal-to-noise ratio than could be achieved if all or more of the light were used.

It is also desirable to include new functionality, if possible, to interferometers.

### SUMMARY OF THE INVENTION

The present invention provides an interferometer comprising: a beamsplitter arranged to divide an input beam into first and second beams or beam portions; path differencing optics, for example comprising at least two mirror regions or mirrors, arranged to direct the first and second beams in opposite directions around a cyclic path and back to the beamsplitter, wherein the beamsplitter is arranged to divide, on return to the beamsplitter, the first and second beams each into transmitted and reflected portions; a first detector array arranged to receive or detect a first interference pattern generated from the transmitted portion of the first beam and the reflected portion of the second beam; wherein one or more components of the path differencing optics, for example the at least two mirror regions, are oriented to direct the first and second beams to be incident on the beamsplitter spatially offset, or spatially diverging, from the input beam position on the beamsplitter; and a second detector array arranged to receive or detect a second interference pattern generated from the reflected portion of the first beam and the transmitted portion of the second beam. The spatial offset or divergence is sufficient to be able to position a detector to collect the desired beam portions without blocking or obscuring the input beam. Alternatively, the spatial offset may be sufficient to position a third mirror to collect the desired beam portions without blocking or obscuring the input beam. The third mirror may direct the desired beam portions to the second detector.

Two mirror regions may mean either two separate mirrors or two regions of one mirror. The spatial offset or spatial divergence is provided by orienting one or more components of the path differencing optics, such as the two mirrors or mirror regions, for example by tilting the mirrors or mirror regions to direct the beams out of the optical plane formed of the beamsplitter and path differencing optics. By spatially offset from the input beam we mean, for example, that at the beamsplitter, the centres of the first and second beams are offset from the centre of the input beam. For example, the offset may be from greater than zero but less than a millimetre or greater than a millimetre. In embodiments the offset is such that there may be a space between the width of the input beam and the widths of the first and second beams, wherein width may defined to mean full width at half maximum or the 1/e² intensity widths.

The path differencing optics may comprise at least two mirror regions or mirrors.

The at least two mirror regions or mirrors may comprise cylindrically curved mirrors or mirror regions, and may be arranged so as to converge the first and second beams onto the detectors. The convergence may be provided in one plane or orientation only,.

Alternatively, the convergence may be in two planes by using doubly curved mirrors such as spherically curved mirrors.

The beamsplitter and the at least two mirror regions, and preferably the input beam and first and second beams as they depart the beamsplitter and are directed towards the path differencing optics, may be arranged in an optical plane. The at least two mirrors or mirror regions are tilted to direct the first and second beams out of the optical plane. The tilt is preferably greater than 0.1° or 0.2° and may be up to 5° or more.

The at least two mirror regions may be tilted to direct beams arriving at the at least two mirrors or mirror regions away from the optical plane to a first side, i.e. the same side, of the optical plane.

The beamsplitter and path differencing optics may be arranged in an optical plane, and the path differencing optics may be arranged to direct the first and second beams out of the optical plane to a first side of the optical plane.

The first and second detector arrays may be arranged offset from the optical plane, the first and second detector arrays offset to the same side of the optical plane.

The first beam may comprise a portion of the input beam transmitted by the beamsplitter and the second beam may comprise a portion of the input beam reflected by the beamsplitter. The path differencing optics and the beamsplitter may be arranged to direct the portion of the first beam reflected at the beamsplitter, and the portion of the second beam transmitted at the beamsplitter, out of the optical plane such as to be offset from the input beam.

The path differencing optics and the beamsplitter may be arranged to direct the reflected portion of the first beam and the transmitted portion of the second beam to generate the second interference pattern at the second detector array positioned offset from the input beam and the optical plane.

Alternatively, the beamsplitter and path differencing optics may be arranged in an optical plane, and the path differencing optics may be arranged to keep the first and second beams in the optical plane and direct the first and second beams offset from, or diverging from, the incidence position of the input beam at the beamsplitter.

The second detector array maybe adjacent to the path of the input beam and in the plane of the input beam.

In a further alternative, the path differencing optics may arranged to offset the first and second beams, on return to the beamsplitter, so as to be offset laterally (to the side) and transversely (above or below) to the incidence point of the input beam on the beamsplitter.

The at least two mirror regions or mirrors may comprise two cylindrically curved mirrors or mirror regions and the at least two cylindrically curved mirrors or mirror regions are curved to converge the beams towards the first and second detectors. The convergence may be in a plane tilted from the optical plane, the tilted plane comprising the beamsplitter and detectors.

The optical path distance from the beamsplitter to the first detector may be substantially the same as the optical path distance to the second detector, for example for detectors of the same type and/or pixel size. If the first and second detectors are different types of detector, for example, visible and SWIR, there may be a difference in optical path difference to the detectors.

The beamsplitter may be adapted to divide the input beam such that the first and second beams have substantially equal intensity, or preferably have equal intensity to within +/−5%.

The interferometer may further comprise a source for generating the input beam.

The first and second detector arrays may be configured to provide simultaneous detection of the first and second interference patterns respectively.

The first and second detectors arrays may be arranged transversely to each other. Sensing elements of the first and second detector arrays may be made of different materials or may be of different sensor types.

The first detector array and second detector array may have different operating wavelengths. The first detector array may have an operating wavelength range w1 to w2 and the second detector array may have an operating range w2 to w3, such that the combined continuous operating wavelength range of the first and second detector arrays is greater than the operating wavelength range of the first or second detector array alone.

One of the first and second detector arrays may be a visible light detector and the other of the first and second detector arrays may be a short-wave infrared, SWIR, detector. One of the first and second detector arrays may be a visible light detector and the other of the first and second detector arrays may be an ultraviolet detector.

Alternatively, the detectors may be any of: a visible light detector, a short-wave infrared detector, an ultraviolet detector, a mid-wavelength infrared detector, a long-wavelength infrared detector, a far infrared detector, a near infrared detector, and an x-ray detector.

The interferometer may further comprise a laser source and a mirror. The mirror may be arranged to direct a laser beam from the laser source via the beamsplitter and path differencing optics to produce interference patterns on the first and second detector arrays. The interferometer may further comprise a first polariser arranged between the beamsplitter and first detector array and a second polariser arranged between the beamsplitter and second detector array, the first and second polarisers being crossed polarisers arranged to transmit orthogonal polarisations of light.

The interferometer may further comprise a diffraction grating arranged between the beamsplitter and the first detector array or second detector array, the diffraction grating arranged to provide diffraction pattern on the respective first detector array or second detector array.

The present invention further comprises a spectrometer comprising any of the interferometers set out herein and an analyser configured to receive signals or data from the first and second detector arrays representing the first and second interference patterns, the analyser configured to generate a spectrum showing the relative spectral contents of the input beam, such as the intensity of the input beam against wavelength.

The analyser may be configured to Fourier transform the signals or data received from the first and second detector arrays representing the first and second interference patterns to produce the spectrum.

The analyser may be configured to use a windowing function on the signals or data received from the first and second detector arrays representing the first and second interference patterns to process the data or signals prior to performing the Fourier transform.

The present invention provides an interferometer comprising: a beamsplitter arranged to divide an input beam into first and second beams; path differencing optics arranged to direct the first and second beams in opposite directions around a cyclic path and back to the beamsplitter, wherein the beamsplitter is arranged to divide, on return to the beamsplitter, the first and second beams each into transmitted and reflected portions; a first detector array arranged to detect a first interference pattern generated from the transmitted portion of the first beam and the reflected portion of the second beam; wherein one or more components of the path differencing optics are arranged to keep the first and second beams in the optical plane and direct the first and second beams to be incident on the beamsplitter spatially offset, or spatially diverging, from an incidence position of the input beam on the beamsplitter; and a second detector array arranged to detect a second interference pattern generated from the reflected portion of the first beam and the transmitted portion of the second beam. The second detector may be adjacent to the path of the input beam.

We describe light such as visible light, infrared or ultraviolet. Herein light is understood to mean any of the types of radiation that can be monitored on a suitable detector and divided by a suitable beamsplitter.

### BRIEF DESCRIPTION OF THE DRAWINGS

Embodiments of the present invention, and aspects of the prior art, will now be described with reference to the accompanying drawings, of which:

FIG. 1 is a schematic diagram of a prior art interferometer;

FIGS. 2a and 2b are respectively schematic side and plan views of an interferometer according to an embodiment of the present invention;

FIG. 3 is enlarged view of the side view of FIG. 2a;

FIGS. 4a and 4b are respectively simulated plan and angled views of the interferometer according to an embodiment of the present invention;

FIG. 5 is a schematic diagram showing an embodiment of the interferometer with additional components added;

FIG. 6 is a graph showing an example spectral response of the interferometer;

FIGS. 7a and 7b show measured 2-dimensional interferograms from visible (FIG. 7a) and SWIR (FIG. 7b) detectors respectively;

FIGS. 8a-8b show the measured interferogram and Fourier transform spectrum for data collected at a visible detector, and FIGS. 8c-8d show the measured interferogram and Fourier transform spectrum for data collected at a SWIR detector;

FIG. 9 shows measured and simulated spectral resolution as a function of wavelength for the interferometer according to an embodiment of the present invention;

FIG. 10a shows the measured normalised broadband spectral signal for visible and SWIR regions, as compared to filter transmittance for spectral bandpass filters as shown in FIG. 10b;

FIGS. 11a-11c show the relationship between the number of fringes and spectral bandwidth as verified using two groups of spectral bandpass filters with different spectral widths;

FIG. 12 is a schematic plan view of an interferometer according to a second embodiment of the present invention;

FIGS. 13a and 13b are respectively simulated plan and angled views of the interferometer according to a second embodiment of the present invention;

FIG. 14 is a schematic diagram of a beamsplitter showing interaction points for various embodiments of the present invention; and

FIG. 15 is a schematic diagram of a spectrometer incorporating the interferometer according to embodiments of the present invention.

### DETAILED DESCRIPTION

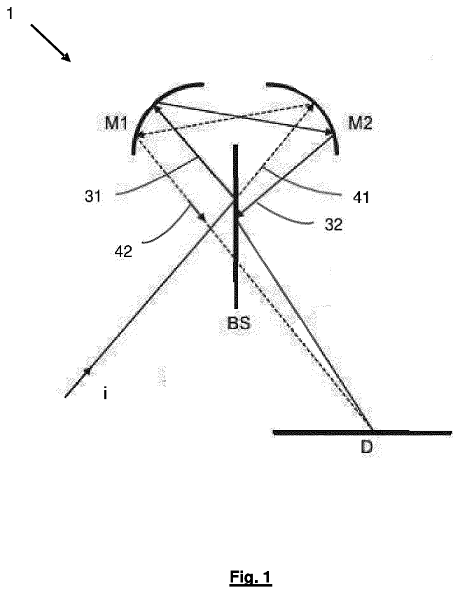

We have described that the interferometer of FIG. 1 has light losses. A difficulty with making use of the light that propagates back towards the detector is that its path is coincident with the input beam. This makes it difficult to collect the lost light without blocking or disturbing the input beam.

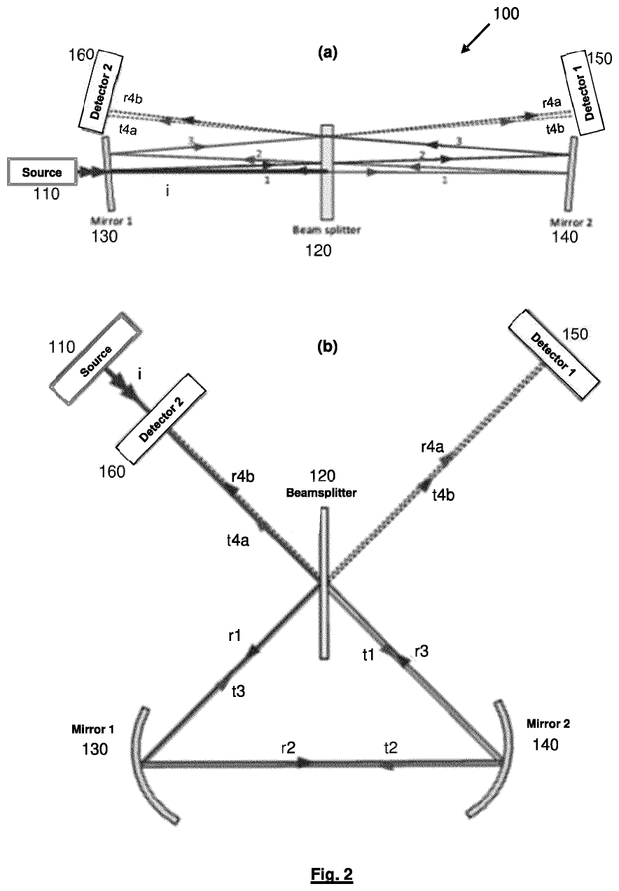

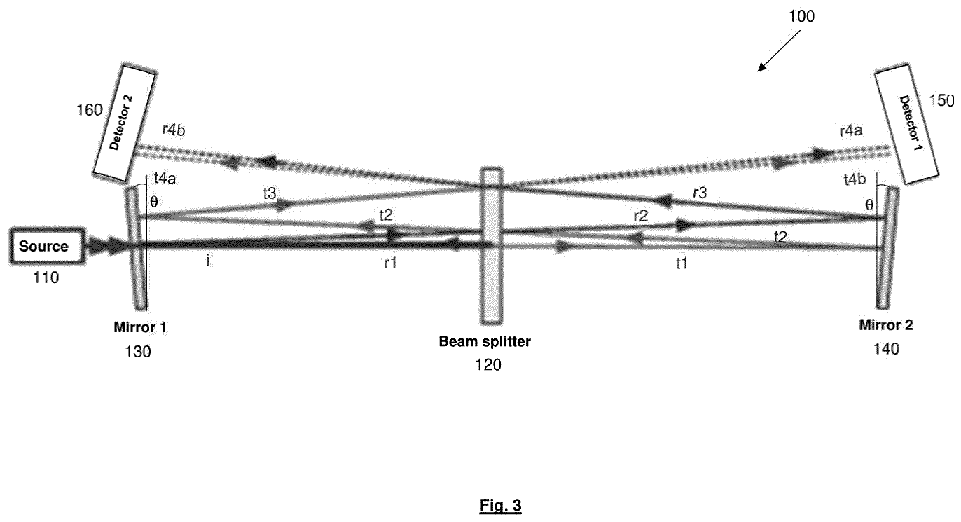

FIGS. 2a and 2b show schematic end and top views of an interferometer 100 according to an embodiment of the present invention. FIG. 3 is an enlarged view of the end view of FIG. 2a. The optical components used are similar to those in FIG. 1 but the layout is changed and an additional detector is added. The interferometer 100 is illuminated by a source 110, and comprises a beamsplitter 120, a first mirror 130, a second mirror 140, a first detector 150 and a second detector 160. The source may be a laser beam or a broadband source, and preferably generates a collimated beam of light. We will discuss possible sources later in the description. The beamsplitter 120 may be a plate beamsplitter and preferably is a 50:50 beamsplitter splitting the incident light into equal portions of transmitted and reflected light. First mirror 130 is preferably a curved mirror such as a cylindrical or concave mirror. A cylindrically curved mirror is used to provide focus or convergence to the beam in one direction only. The cylindrically curved mirror has an axis of curvature which, based on the orientation of FIG. 2, is arranged in a direction extending out of the page. Second mirror 140 is substantially the same as the first mirror 130. First and second mirrors may alternatively be spherical mirrors. The first and second detectors 150 and 160 are detector arrays.

The source generates an input beam i which is incident on the beamsplitter 120.

The input beam i is incident on the beamsplitter at around 45°. The beamsplitter divides the beam into transmitted and reflected portions, which preferably are equal intensity. The transmitted portion, t1 in FIGS. 2 and 3, has passed largely straight through the beamsplitter leaving the beamsplitter on largely the same trajectory as the input beam i arrived at the beamsplitter. There may be some offset between the input beam path and the beam path of transmitted portion due to refraction through the beamsplitter surfaces.

The reflected portion, r1, leaves the beamsplitter at around 45° to the beamsplitter surface but around 90° to the input beam direction. Hence, the transmitted t1 and reflected r1 beams are separated by around 90°. Other angles of incidence to the beamsplitter may be used and correspondingly the reflected r1 and transmitted t1 beams may leave the beamsplitter at different angles to those described here. As can be seen in FIG. 2a the source 110 along with the mirrors 130, 140 and beamsplitter 120 may be considered to lie in an optical plane. The input beam i, the transmitted beam t1 and the reflected beam r1 are also considered to travel in or form the optical plane.

The transmitted beam t1 and reflected beam r1 respectively propagate to the mirrors 140 and 130. Mirrors 130 and 140 are tilted from normal to the optical plane and hence are tilted from normal to the transmitted beam t1 and reflected beam r1. The angle of tilt of the two mirrors is substantially the same and may be in the range 0.1° to 5.0° and more preferably in the range 1-2° such as 1.25°. For compact designs of interferometer, the angle of tilt may be greater than 5° such as up to 10°. The actual tilt will depend on the size of the device, the beam size, the size of the mirrors etc. As shown in FIG. 2a both mirrors are tilted to the same side of the optical plane, that is, in the embodiment of FIG. 2a they are both tilted upwards.

The transmitted beam t1 is reflected from mirror 140 and the tilt of the mirror causes the beam t1 to be reflected upwards slightly such that it propagates at an angle away from the optical plane. This is denoted by t2 in FIG. 3. If the angle of tilt of the mirrors is θ/2 to normal, the beam t2 will be reflected at the mirror at an angle θ to the incident beam t1 and the horizontal or in-plane direction.

The beam r1 reflected from the beamsplitter is incident on mirror 130 and reflected upwards at the same angle as the transmitted beam t1 at mirror 140. That is, reflected beam r1 is reflected upwards at an angle θ on leaving mirror 130, due to the tilt of mirror 130 at angle θ/2. Hence, beam r1 is reflected upwards from the optical plane and is denoted by r2 in FIG. 3.

Beams r2 and t2 travel on to the other of the mirrors. That is, beam r2 propagates to mirror 140 and beam t2 propagates to mirror 130. The tilt on the mirrors causes the beams to be reflected upwards further again and now propagate at 20 to the optical plane. Hence, for an original tilt on the mirrors, of for example 1.25°, after a first reflection results in the beams propagating at 2.5° to the horizontal, and after the second reflection results in the beams propagating at 5° to the horizontal or optical plane as they travel from the second mirrors back towards the beamsplitter 120. The beams are now designated as r3 and t3 in FIG. 3.

The reflections from the first of the mirrors for both the transmitted beam t1 and reflected beam r1 are preferably at the centre of the mirrors laterally. The second reflections are also preferably at the centre of the mirrors laterally, but moved upwards, for example, in height.

The beams arrive back at the beamsplitter 120 and the beamsplitter again divides the beams. Half of beam r3 is transmitted through the beamsplitter and the other half of the beam r3 is reflected at beamsplitter. These are denoted as r4b and r4a respectively in FIG. 3. Correspondingly, half of beam t3 is transmitted through the beamsplitter and the other half of the beam t3 is reflected at beamsplitter. These are denoted t4b and t4a in FIG. 3.

The two halves of input beam i have propagated along similar paths around a loop. The beam r1 has propagated from beamsplitter 120 to mirror 130 and further to mirror 140 and back to the beamsplitter. Beam t1 has propagated from beamsplitter 120 to mirror 140 and further to mirror 130 and back to beamsplitter 120.

There are now four beams or beam portions propagating from the beamsplitter having passed around the loop, which can be summarised as follows:
r4b, having been reflected at first incidence at the beamsplitter and then transmitted at second incidence at the beamsplitter;
t4a, having been transmitted at first incidence at the beamsplitter and then reflected at second incidence at the beamsplitter;
r4a, having been reflected at first incidence at the beamsplitter and then reflected at second incidence at the beamsplitter; and
t4b, having been transmitted at first incidence at the beamsplitter and then transmitted at second incidence at the beamsplitter.

Beam portions r4b and t4a are incident at second detector 160 and beam portions r4a and t4b are incident at first detector 150. Interference patterns are formed at the detectors due to the beam portions taking slightly different paths around the loop and on to arrive at the detector. The different paths result in an optical path difference (OPD) which results in the interference pattern. The first and second detectors are located above the optical plane. The second detector is located above the input beam i. Without the tilt on the mirrors it would not be possible to include the second detector because it would sit in the path of the input beam blocking its path. The mirrors 130, 140, are preferably curved and the detectors may be placed at the focus of the beams resulting from the curvature of the mirrors. Cylindrically curved mirrors focus the beam in the in-plane direction only. For example, if the mirrors were not tilted this would mean that the mirrors would focus the beams in the optical plane direction and in the direction transverse to the optical plane the beams would not be focussed by the curved mirrors. With the mirrors tilted the focus direction is slightly tilted from the optical plane. For example, with reference to FIG. 2b the mirrors focus in a plane tilted up from the plane of the page to the detectors and do not focus in the direction transverse to the page.

The path difference may be set by having one of mirrors 130 and 140 positioned slightly further away from the beamsplitter than the other. The one mirror may be moved by around a 1 mm or more. The path difference may be from around 1 mm to a few cm depending on the size and spacing of components. Additional or other optical components may be used with or instead of the mirrors 130 and 140 to provide optical paths having a path difference. Accordingly, the mirrors 130, 140, and/or other optical components may be considered to form path differencing optics.

As mentioned, the two beam portions arriving at the first detector comprise beam portion r4a reflected at both incidences at the beamsplitter and beam portion t4b transmitted at both incidences at the beamsplitter. Since there is a T phase change on reflection at a higher refractive index medium, the double reflected beam portion will experience two a phase changes. Accordingly, the phase change caused by the double reflections sum to zero. The double transmitted beam does not experience a phase change at an interface to a different refractive index medium. Hence, the phase difference of the double reflected beam portion compared to the double transmitted beam portion (resulting from interactions with the beamsplitter) is zero.

The two beams arriving at the second detector comprise beam portion r4b reflected at first incidence at the beamsplitter and transmitted at the second incidence, and beam portion t4a transmitted at first incidence at the beamsplitter and reflected at the second incidence. Since both beam portions have been reflected at the beamsplitter once, each has experienced a phase change of T and the total phase difference between both beams (resulting from interactions with the beamsplitter) is zero.

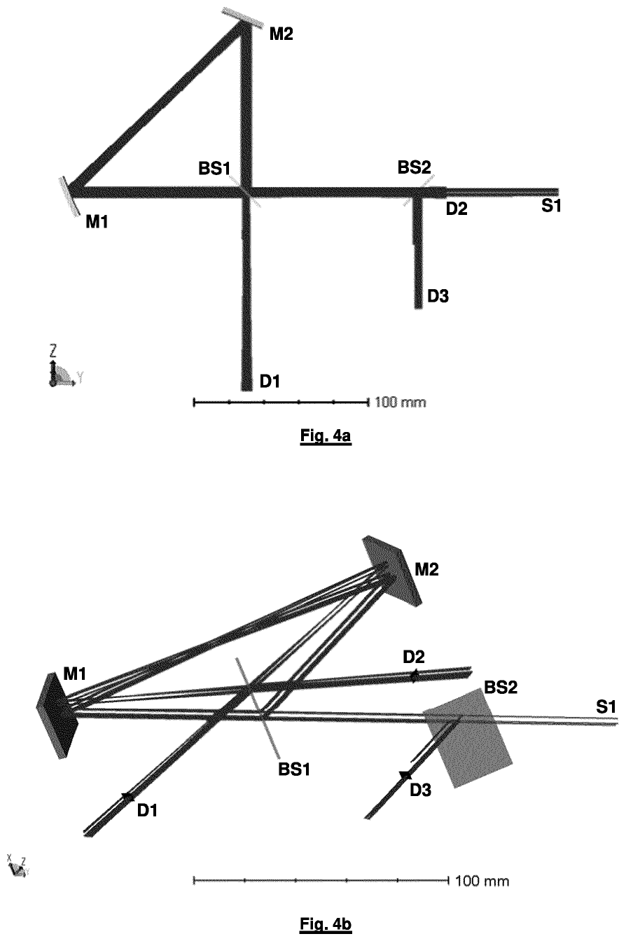

The mirrors 130, 140, or path differencing optics, may be arranged to direct the transmitted portion back to a point on the beamsplitter which is close to, or the same as, the point at which the reflected beam arrives back at the beamsplitter. The tilt on the mirrors means that this point will be slightly offset from the position that the input beam i is incident on the beamsplitter. In FIGS. 2a and 3 this point is shown as slightly higher than the point the input beam is incident on the beamsplitter, but more generally for mirrors tilted as described above, the incidence point will be offset transversely out of the optical plane. FIGS. 4a and 4b show an optical layout similar to that of FIGS. 2 and 3 but with an additional beamsplitter BS2 and detector D3 added. FIG. 4a is a top view of the optical design generated in Zemax® optical design and modelling software. FIG. 4b is an angled view. In FIG. 4b the different heights of the incoming beam passing through the beamsplitter and the beams returning to the second detector can be more clearly seen.

The different points of incidence on the two mirrors of the transmitted or reflected beams can also be seen clearly. Again, on each mirror the different incidence positions is seen as a height difference on the mirrors, as previously discussed in relation to FIG. 3. The extra beamsplitter and detector shown in FIGS. 4a and 4b are not needed for the interferometer and may be used to analyse the input beam intensity profile. FIGS. 4a and 4b are provided because the angled view of FIG. 4b provides a further visualization of the arrangement of the beams and in particular allows the effect of the tilt on the mirrors to be seen on reflecting the beams above the optical plane and towards the second detector D2 which is shown above the input beam.

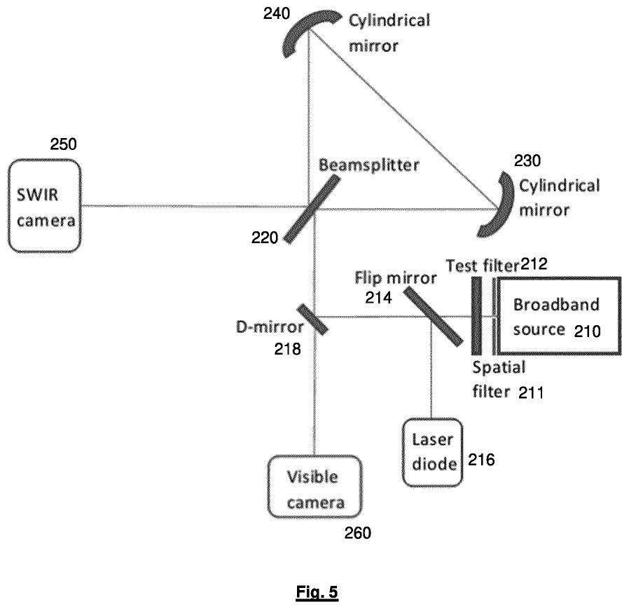

FIG. 5 is a schematic diagram showing an embodiment of the interferometer described above, but with additional components added. The two detectors are different and have been selected to operate at different but adjacent wavelength ranges such that their combination provides a broadband spectrometer. We now describe the embodiment of FIG. 5 in more detail. In this figure the input source is a broadband source 210 such as a quartz Tungsten-Halogen lamp. The light from the source is collimated and passed through an aperture, indicated in the figure by spatial filter 211. The aperture or spatial filter may be a 5 mm diameter aperture. The spatial filter may be used to improve coherence length of the optical beam. In FIG. 5 after the spatial filter is a test filter 212. This was used to filter the broadband input light to a known narrow wavelength line for testing of the interferometer and would not be required in a manufactured unit. Next in FIG. 5 are flip mirror 214 and laser diode 216. The laser diode is used for calibration. It may be a 403 nm/978 nm laser source that may be directed into the interferometer for calibration of the optical path difference between the two paths around the interferometer for each detector. The flip-up mirror 214 is used to selectively insert the laser beam from the laser 216 when it is desired to make a calibration of optical path difference OPD. When not in use the mirror can be moved out of the way of the beam from the broadband light source, D-mirror 218 is a semi-circular shaped mirror. A mirror of this shape is used because the flat edge can be moved in close to the path of the beam going to the second detector but without disturbing that beam. D-mirror reflects the input beam towards the beamsplitter 220 of the interferometer. Beamsplitter 220, mirrors 230 and 240, first detector 250 and second detector 260 correspond to similar named items in the embodiments of FIGS. 2-4.

The light from the broadband source is incident on the beamsplitter at around 45°. The beamsplitter is preferably a 50:50 beamsplitter dividing the beam into two orthogonal beams, namely a transmitted beam and a reflected beam. The beamsplitter 220 may be a broadband dielectric beamsplitter. The mirrors 230, 240, are preferably cylindrically curved mirrors such as silver coated cylindrical mirrors. The cylindrical mirrors are tilted to raise the beam path out of the optical plane. The beamsplitter works in both directions, that is, with a beam incident from one side it is divided 50:50 into transmitted and reflected beams. The same is true for a beam incident on the other side of the beamsplitter. A first detector 250 is a short-wave infrared detector which is positioned at the focus of the interferogram. The second detector 260 is a visible detector which is placed at the focus of the second interferogram. The beams passing to the second detector 260 pass over the top of D-mirror 218.

### Components

We have described above some of the components that may be used for the interferometer. We now describe more detail and other possibilities for the various components. The examples provided below were used in a demonstration interferometer. Other components may be used.
Mirrors—Concave cylindrical mirrors are used because they reflect light and focus it in one direction without introducing chromatic aberration. A silver coating is preferred because it has the highest reflectance and over a broadband spectral range. The substrate may be UV fused silica. 400 mm focal lengths were used but smaller or larger focal lengths may be used. The focal lengths of the two mirrors should be the same as each other.
Beamsplitter—As mentioned, a 50:50 beamsplitter is preferred. A dielectric type has been mentioned. Dielectric type beamsplitters work based on having precisely formed layers of different dielectric materials which cause interference in beams reflecting and propagating in the layers. Another possibility is the polka-dot type of beamsplitter. The polka-dot type beamsplitter has small mirror portions deposited across a substrate. The mirror portions may form a polka-dot pattern. Incident light hitting the mirror portions is reflected whereas incident light that does not hit a mirror portion is transmitted. Hence, the beam is split. A possible advantage of polka-dot beamsplitter is that they may be available covering wider wavelength bands than dielectric types of which the layers are precisely formed depending on the desired wavelength of operation. A disadvantage of the polka-dot type is that it may make analysis of interferograms more difficult. A possible dielectric beamsplitter is a UV fused silica plate beamsplitter with a coating tailored for 350-1100 nm. A rectangular shaped beamsplitter is preferable to accommodate the offset between the input beam and beams going to the two detectors. The polka-dot type may again be a fused silica substrate but with an aluminium coating. Polka-dot beamsplitters are also less sensitive to angle of incidence of the light but may be less accurate in achieving a 50:50 split.
Detectors—For a broadband interferometer it is desirable to use detectors of different but adjacent ranges of operating wavelength. The detectors are detector arrays having an array of pixels or an array of sensing elements. To achieve this it is likely that different detector materials or types will be required. In one example, a silicon-based detector array is used which has an operating wavelength range from 400 nm to 1050 nm. An InGaAs based detector array is used for the other detector and has an operating wavelength range from 950 nm to 1800 nm. Other detectors and wavelength ranges of operation may be used. For example, the two detectors described here together provide a broadband interferometer operating across the visible and short-wave infrared (SWIR). In one example, a visible detector array had a size of 3.73×4.83 mm and the SWIR detector array had a size of 7.20×9.60 mm. Other sizes of detector may be used. Other operating ranges are possible such as the UV and visible range, visible-to-near infrared-to-shortwave infrared, or midwave and longwave infrared. Each of these may require two detectors of different types of semiconductor materials. Alternatively, the operating ranges of the detectors may not be adjacent but may have a gap between them. This could be used where there are two spaced apart wavelength ranges of interest. In another embodiment the two detectors may be the same. This would not achieve an interferometer having such a broad wavelength bandwidth of operation but could provide an interferometer having improved signal-to-noise ratio over a narrower bandwidth. This embodiment will be discussed further later in the description.
Broadband source—As mentioned above, the broadband source may be a quartz tungsten-halogen lamp. Such lamps provide broadband emission from around 400-2200 nm. Other blackbody radiation sources may be used or multiple sources may be used.
Laser diode—As mentioned, this may optionally be included for calibration purposes. A laser having a circular beam profile, operating in the visible spectral range is preferred. For example, a diode laser operating at 635 nm or 532 nm could be used but other wavelengths may be used.

The use of two detectors having different operating wavelengths allows a broadband interferometer or spectrometer to be built. We will now describe the response of the interferometer.

### Spectral Response

The spectral response, S(λ), of a broadband spectrometer can be calculated using the expression below:

$$S ( λ ) = 2 ( I ( λ ) L ( λ ) {M ( λ )}^{3} B {S}_{R} ( λ ) B {S}_{T} ( λ ) ) ( {D}_{VIS} ( λ ) + {D}_{SWIR} ( λ ) )$$

where D_{VIS/SWIR}(λ) is the normalised detector's spectral response for both visible/SWIR detector arrays, I(λ) is the spectral output from the broadband source such as the quartz tungsten-halogen lamp which may be defined by Planck's blackbody radiation for a source at 2800 K. M(λ) is the reflectance of the silver coated mirrors, L(λ) is the transmittance of a light source collimating lens, BS_{T}(λ) and BS_{R}(λ) are respectively the transmittance and reflectance response functions of the broadband beamsplitter.

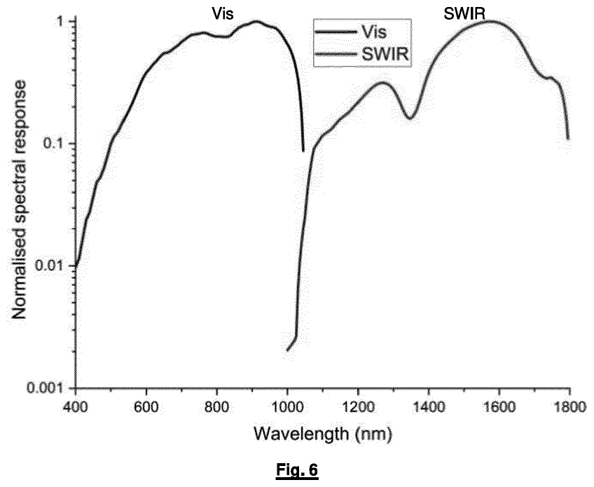

An example calculated total spectral response of the broadband interferometer is shown in FIG. 6. This takes into account the performance of the various components identified in the preceding equation. The spectral response is made up of two curves because of the two detectors. Lower response levels near 400 nm and 1050 nm are due to reduced quantum efficiency of the Si and InGaAs detector arrays, respectively. The drops just after 1300 nm and 1700 nm are the result of dips in beamsplitter performance. The detector performance used is only an example and detectors with better performance overlap would be preferred.

### Spectrometer Calibration and Analysis Procedure

The interferometer, such as set out in FIGS. 2-5, requires alignment of the optical components. This may be performed using laser diode 216 in FIG. 5. In one embodiment this was performed using coherent sources at 403 nm and 978 nm. The optical path difference is optimised. Nyquist theory puts a lower limit on the number of measurement points per fringe to avoid aliasing as two measurement points per fringe. The highest resolution is achieved by adjusting the optical path length difference to operate as close to the Nyquist limit for the shortest wavelength it is needed to measure. This results in maximizing the total number of fringes observed within the detector array length. The mirrors and beamsplitter are initially set with equal distances from the beamsplitter to the two mirrors and the beam travelling anticlockwise around the mirrors overlaps the path of the beam travelling clockwise. The optical path difference is then adjusted by moving one of the mirrors, for example, away from the beamsplitter, such as by 1-2 mm, and then the rotational position of both mirrors in the optical plane is adjusted to align the beams together to form an interferogram on the detector array. Once aligned in the optical plane, the mirrors are tilted upwards, for example, to move the beams leaving the mirrors to be directed sloping upwards out of the optical plane. The detectors are correspondingly moved upwards.

The size of the fringes is optimized by moving the mirrors for example, mirrors 130, 140 or 230, 240 horizontally or in the optical plane, to set adjust the optical path difference. Once the size of the interferogram fringes are optimised, the tilt of the fringes is removed as best as possible with rotation and/or tilt of the detectors. The interference spot is centralised by moving the detector in the x-y axis. The focus position of the detector is moved to achieve best fringe visibility.

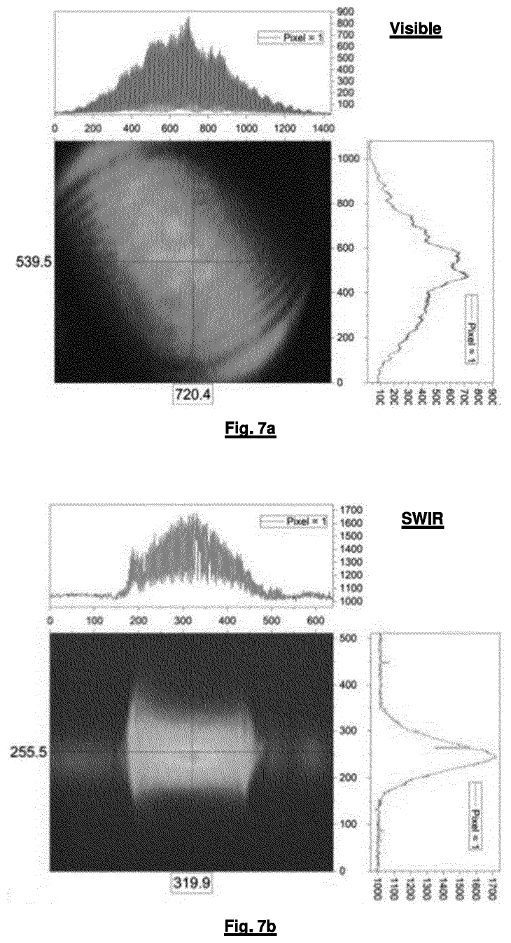

Measured 2-dimensional interferograms from the visible and SWIR detectors are shown respectively in FIGS. 7a and 7b. Fringes can be seen with the lighter regions representing higher intensity regions on the detector. The numbers at the bottom and left-hand side of the 2-dimensional plot represent the pixel values at which cross-sectional plots are taken. The cross-sectional plots are also shown. The cross-sectional plots above the 2-dimensional plots are slices through the 2-dimensional plots along the horizontal line at 539.5 on the vertical axis for the visible detector and at 255.5 on the vertical axis for the SWIR detector. These cross-section plots shows the fringes of the interferogram. In these plots there is a solid line and some shading around the solid line. The solid line is the cross-section line. The laser beam profile and distortion produce some variation which is represented by the shading. The cross-sectional plots to the right of the two-dimensional plots show the intensity and are taken as slices along the vertical lines at 720.4 and 319.9 (respectively for the visible and SWIR detectors) on the horizontal axis.

The 403 nm source is used to generate the interferogram collected on the visible detector and the 978 nm source is used generate the interferogram collected on the SWIR detector. The spot size from both sources are roughly the same. The SWIR detector array has a 15 um pixel size (and fewer pixels) than the 3.45 um pixel size for the visible detector array. The visible and SWIR detector arrays have a size of 3.73×4.83 mm and 7.20×9.60 mm, respectively. Other array sizes may be used and preferably the arrays would be of equal size but with a factor of 2 difference in pixel length with SWIR pixels being larger to match the overall resolutions for the different fringe sizes between the two measurements. Equal overall size of detectors is preferred to match the equal beam size on the two detectors.

In the following we set out the analysis steps for arriving at spectral information from the 2-dimensional plots. A source with a known or previously calibrated wavelength is first used to determine the change in optical path difference across the detector. For example, if a calibrated source at 400 nm is used with the interferometer and generates fringe maxima (or minima) every five pixels, then it is known that the path difference between fringes is 400 nm. Over five pixels this is an optical path difference of 80 nm/pixel. This needs to be performed separately for each detector with a suitable source that the detector is able to detect. For example, a 405 nm or 400 nm laser may be used for the visible detector and a 980 nm laser for the SWIR detector.

To arrive at the spectral information the following steps are performed.
1. The image of the interferogram is recorded at the detector and data describing the image may be converted into a matrix.
2. Optionally, average 10 rows (or more) around the centre row to improve signal-to-noise ratio, keeping the centre still at maximum signal.
3. The averaged row data is plotted against pixel number or column number.

4. Count the total number of fringes (n) across the whole (or part of the detector) and count how many pixels (p) the counted fringes span across.
5. Calculate the number of pixels per fringe (p/n).
6. Using the previously obtained calibration information relating to optical path difference from the calibration source (for example, 80 nm/pixel) convert the row data vs column number from step 4 to produce a plot with an x-axis scale of nm instead of column number.
7. For ease of converting the data to wavenumbers (2-1), optionally convert the x-axis (OPD) to cm to produce a plot of averaged row interferogram against OPD
8. Perform FFT on interferogram.
9. If the optional conversion to cm was performed at step 8, then the Fourier transformed plot will have cm-1 on the x axis, which can be readily converted to nm if desired. The resultant plot is the desired spectral information.

### Experimental Results

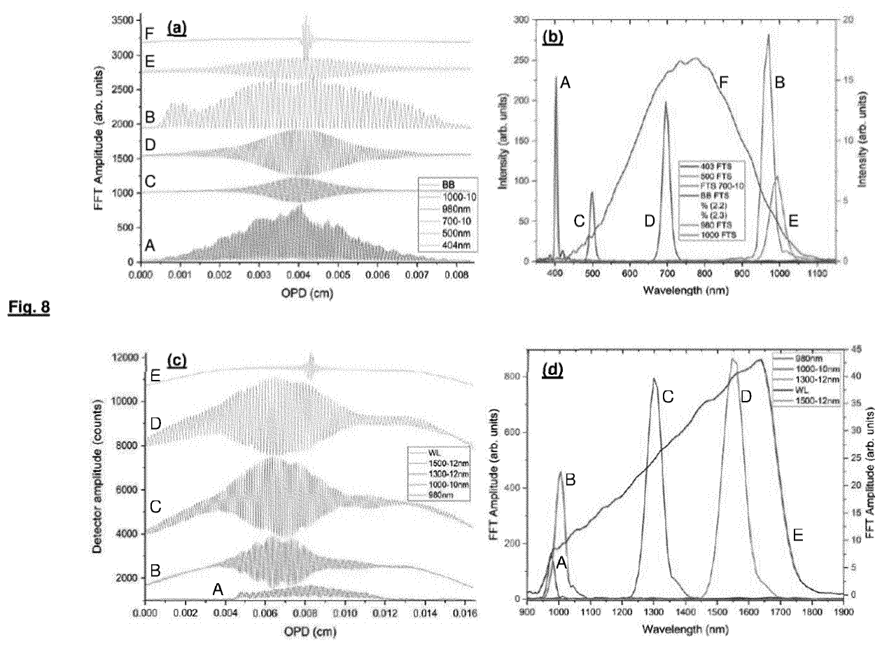

Results have been obtained in the visible and SWIR. These are shown in FIGS. 8a-d. FIG. 8a shows the measured interferogram and FIG. 8b shows the Fourier transform spectrum for data collected at the visible detector. Six sets of data are shown.

The data is for laser sources at 403 nm and 978 nm and a broadband white light source that has passed through bandpass filters at 500 nm, 700 nm and 100 nm, as well as the broadband white light source with no filtering. The interferograms and spectra are labelled as follows:
A. 403 nm laser
B. 978 nm laser
C. 500 nm bandpass filter
D. 700 nm bandpass filter
E. 1000 nm bandpass filter
F. Broadband white light source

FIGS. 8c and 8d show similar data collected using the SWIR detector as a measured interferogram and Fourier transform spectrum. Five sets of data are shown. The data is for a 978 nm laser source, bandpass filters at 1000 nm, 1300 nm and 1550 nm illuminated by a broadband white light source, and the broadband white light source with no filtering. The interferograms and spectra are labelled as follows:
A. 978 nm laser
B. 1000 nm bandpass filter
C. 1300 nm bandpass filter
D. 1550 nm bandpass filter
E. Broadband white light source

From the measured interferograms, the laser sources (A, B in FIG. 8a and A in FIG. 8c) show higher fringe visibility due to their coherence and have an asymmetric envelope profile. The broadband source shows fewer fringes as expected. The difference in array size can be seen in the optical path difference (OPD) shown on the x-axis of the measured interferogram.

The corresponding spectral profiles show predicted behaviour. The accuracy of the spectrometer is 4.9 nm and 2.3 nm for the visible and SWIR spectral regions, respectively, as determined from known spectral bandpass filters and use of a calibrated spectrometer. The spacing between adjacent points in wavelength space will be different for the two detectors and this will vary across the wavelength range because of the Fourier transform process. For the visible detector, the spacing between adjacent points is 2/6/12 nm respectively at 400/700/1000 nm. For the SWIR detector, the spacing between adjacent points is 6/10/15 nm for 1000/1300/1550 nm, respectively. This is not spectral resolution because to resolve a peak or trough at least 3 points are needed.

### Resolution

The spectral resolution is influenced by several variables and has a theoretical lower limit. The Nyquist limit requires sampling at least twice the highest frequency. This should be doubled when measuring fringes on detector arrays to prevent any aliasing in sampling. To satisfy Rayleigh Criterion for resolving adjacent peaks, their centres should be separated by the width of the peaks.

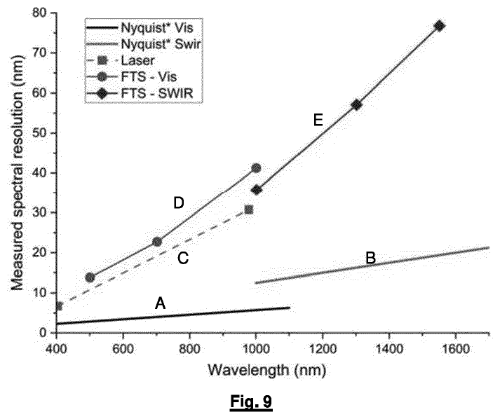

The spectral resolution as a function of wavelength for the interferometer is shown in FIG. 9. Since the detector arrays have different sizes, the theoretical limits for each of them are different. In FIG. 9, lines A and B are the theoretical (simulated) resolutions for visible and SWIR detectors, respectively. The predicted higher resolution for the visible detector is due to the larger number of pixels. Two lasers were used for calibration (namely at 403 nm and 978 nm) and are shown by the line C. The visible and SWIR measured spectral resolutions using narrow bandpass filters are shown as lines D and E, respectively. The resolution for the visible detector was limited since the difference in pixel size between the two detector arrays is more than a factor of 4 which prevented the fringes being brought together more tightly on the detector. The effects of coherence length and beam diameter can further explain the difference between measured and calculated spectral resolution.

### Signal-to-Noise Ratio

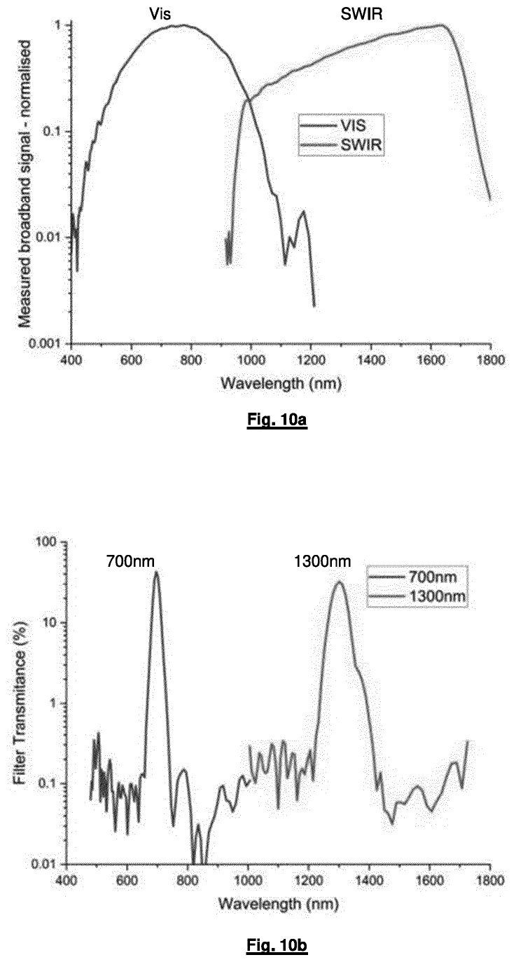

Signal-to-noise ratio (SNR) is a measure of the amplitude of the signal over the rms noise level (the standard deviation of the noise level without the signal). This is a measure of how well an instrument can measure a signal. The measured normalised broadband spectral signal for the visible and SWIR regions is shown in FIG. 10a. There is good overlap observed near 1000 nm between both spectral regions. Based on calculating SNR as peak signal divided by one standard deviation of the noise level, I maximum SNR for both spectral regions is approximately 100 and at the extreme spectral regions the SNR drops below 10. In the case for spectral bandpass filters as shown in FIG. 10b, the best SNR is 533 at 700 nm and 200 at 1300 nm. This difference in SNR is due to the difference in camera noise between Si and InGaAs detectors (and pixel size) and stray light contributing to more noise. The broadband source has reduced SNR due to a reduced number of fringes and reduced fringe peak-peak height in the interferogram. Taking the square number of averages for frames and pixel rows (for 2D arrays) can reduce noise further.

### Fringes and Spectral Bandwidth

In Fourier Transform theory, the Fourier Transform of a continuous sine wave will have a Dirac delta function spectral profile, and the Fourier Transform of a Dirac delta function will have a very large (almost continuous) spectral bandwidth. In other words, the spectral bandwidth is inversely proportional to the number of fringes observed. The number of fringes observed is also proportional to the amplitude in the frequency domain.

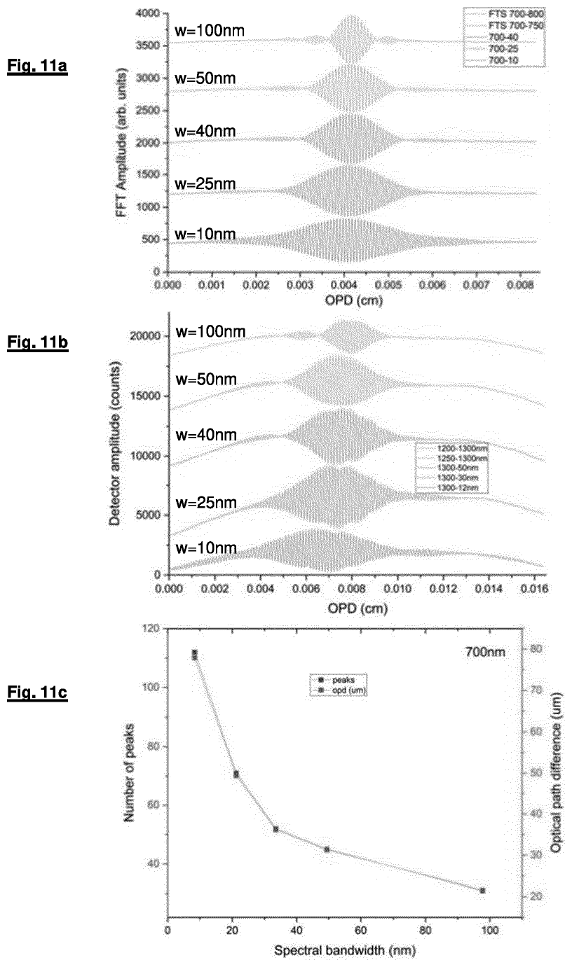

The relationship between number of fringes and spectral bandwidth was verified using two groups of spectral bandpass filters with different spectral widths. The results are shown in FIGS. 11a-11c. FIG. 11a shows the interferograms produced by the visible detector for five bandpass filters with different bandpass width, each centred at 700 nm. The width of the bandpass filters is 100 nm for the top interferogram and then respectively 50 nm, 40 nm, 25 nm and the bottom interferogram is for a filter of width 10 nm. FIG. 11b shows interferograms for another five bandpass filters with different bandpass widths, but these are centred at 1300 nm and produced by the SWIR detector. The width of the bandpass filters is 100 nm for the top interferogram and then respectively 50 nm, 50 nm, 30 m and the bottom interferogram is for a filter of width 12 nm. Both plots clearly show that the number of observed fringes is inversely proportional to the spectral bandwidth of the input source. For example, in FIG. 11a the top interferogram has the least number of fringes and is the widest bandwidth filter. For the visible region, a plot of the number of fringes against spectral bandwidth is shown in FIG. 11c. The curved baseline observed for the interferograms in FIG. 11b for the SWIR is due to beam profile collimation edge effects since the SWIR camera is twice the dimension of the visible camera.

### Effect of FFT Windows

A windowing function can be used in performing the Fourier transform such as a Fast Fourier Transform (FFT). The window function takes the interferogram data and limits the data that is used in the FFT. For example, if a rectangle function is used this removes edges of the data. Window functions are used to eliminate noise, such as may be found at the edges of the detector. Other types of windowing functions can be used instead, with the type of windowing function dependent on the source input. Studies have measured windowing functions in both visible and SWIR spectral regions. Four different types of source inputs were studied, namely: laser, white light source, narrow bandpass filter, and multiple spectral peaks filter. The FFT window functions studied were: rectangle, Blackman, Hamming, Hanning, Gaussian, and triangle. For the case of lasers (with narrow bandwidth) the SNR is found to be better using Blackman windowing but better resolution is achieved using rectangle or Gaussian windowing. For broadband sources, Blackman windowing results in better SNR but using Gaussian or rectangle functions does not reduce the FWHM value.

If multiple peaks are present, the Blackman function gives better resolution with deeper peaks and troughs and the SNR is higher as compared to a rectangle function.

The Blackman function gives best SNR for single and multiple peak sources. Rectangular or Gaussian give high resolution for single peak sources. At longer wavelengths and/or wider spectral bandwidths, the differences between FFT window functions are reduced. In a preferred embodiment of spectrometer instrument, the FFT window function is dynamically selected between different functions depending on the input source and user requirements (high resolution or SNR).

### Alternative Embodiments

We discussed in relation to FIGS. 2 and 3 that the tilt on the mirrors 130, 140 and 230, 240 shifts beams of the interferometer from being directed back in the direction of the input beam and input source. The beams are shifted such that they propagate offset from, that is, above the optical plane and the input beam such the light from these beams is not lost but is collected on the second detector. The second detector may have a different operating wavelength to produce a broadband spectrometer.

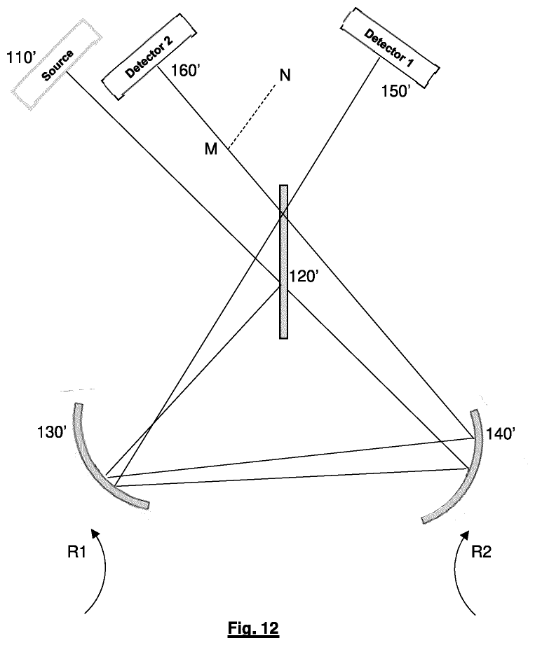

We now describe alternative embodiments. In a first alternative embodiment we describe an alternative offset direction. Instead of offsetting the beams above the optical plane by tilting the mirrors, the mirrors are adjusted to move the returning beams to be incident on the beamsplitter to the side of the input beam. This could be by moving the returning beams to be incident on the beamsplitter closer to the mirrors (for example, down the page in FIG. 12) or closer to the detectors (for example, up the page in FIG. 12). It is preferable to move the returning beams along the beamsplitter towards the detectors (up the page in FIG. 12) so the detectors are less likely to collide with the source beam. This is shown in more detail in FIG. 12 which is a schematic diagram similar to FIG. 2. The components are the same as in FIG. 2 and comprise a source 110′, a beamsplitter 120′, mirrors 130′ and 140′, and detectors 150′ and 160′. The change in numbering from, for example, 110 to 110′, by adding an apostrophe or dash is to denote a possible change in positioning for this embodiment compared to FIG. 2. The two mirrors are rotated in the directions of the arrows R1 and R2 to move the interaction position of the beams the second time they hit the beamsplitter. The second interaction position with the beamsplitter is moved along the beamsplitter away from the beam path loop provided by mirrors 130′ and 140′. For the beam from the source that has been transmitted through the beamsplitter to mirror 140′, the position of the mirror 140′ is rotated such that when the beam hits the second mirror 130′ it is incident on the mirror slightly closer to mirror 140′. This means that it can be reflected to the beamsplitter further along the beamsplitter. The beams are not reflected out of the optical plane in this embodiment and they are kept in the optical plane. This may have advantages in terms of alignment and manufacturability. However, with the interferograms spread across the detectors in the optical plane, the beams need to be offset sufficiently that there is enough space to be able to accommodate detector 160′ next to the input beam from the source without blocking or clipping the input beam. A larger beamsplitter may be used to provide extra space and allow the second interaction point to be moved further away from the first interaction point with the beamsplitter. Alternatively, instead of accommodating detector 160′ next to the input beam another mirror, such as an edge mirror, D-shaped or semi-circular flat mirror, may be placed close to the input beam to reflect the beam returning from mirror 130′ towards detector 160′. Detector 160′ is positioned in a different place to that shown in the figure, such as placed further away from the source 110′ and input beam. For example, the additional mirror could be placed at around the position M in FIG. 12 and detector 160′ could be positioned close to detector 150′ but nearer to the beamsplitter to equalise beam path lengths, such as at position N in the figure. The dashed line in FIG. 12 shows the path of the beam in this configuration reflected from mirror at M to detector at N.

In FIG. 2 the mirrors 130, 140, were tilted upwards by up to around 5° such as around 1.25°. In the present case the mirrors are instead rotated about their cylindrical axis, or an axis parallel to their cylindrical axis, for example by similar amounts to the amount in FIG. 2. The actual amount of rotation for the in-plane embodiment will also depend on the size of the beam, components and interferometer size. In one embodiment the rotation may be 0.5-1.5° such as 0.9°. In the arrangement shown in FIG. 12, the beams returning to the beamsplitter, having being reflected at the mirrors, are incident at the beamsplitter close to 45°.

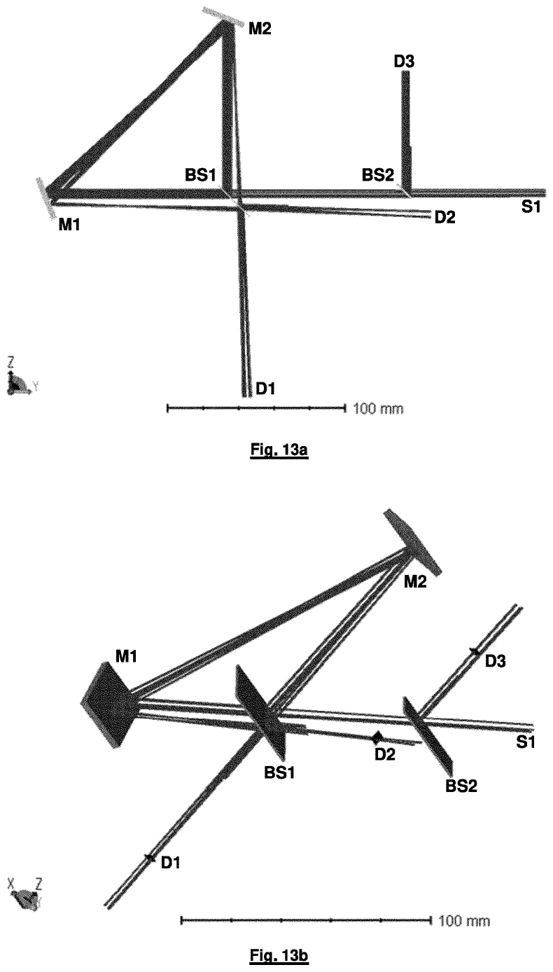

FIGS. 13a and 13b respectively show a further plan view of the optical layout and a view of the optical layout from an angle. These are similar to the views of FIGS. 4a and 4b. In comparison to FIGS. 4a and 4b the third detector has been moved to the opposite side of the input beam to allow for the second detector to image the interferogram.

Results are similar to the embodiment described earlier with the out-of-plane beams. For the embodiment of FIGS. 12 and 13 there may be observed tilt in the interferograms which moves the intensity spread partly towards one end of the interferogram, for example to produce a skewed Gaussian profile, rather than the more usual Gaussian spread of the earlier embodiments. This is caused by having the beams incident on the curved mirrors away from their centres and/or at greater angles of incidence.

In comparing this in-plane interferometer with the out-of-plane interferometer described in relation to FIGS. 2 and 3, the out-of-plane interferometer can be made more compact because there is no need to have a larger beamsplitter to accommodate the second interaction point offset from the first. Also the slight offset of the beams from the centre of the mirrors for the in-plane interferometer means that these mirrors may also need to be larger. As well as the size of the device, these factors also make the out-of-plane interferometer better suited to larger beams with easier alignment requirements, especially if keeping the device compact is important.

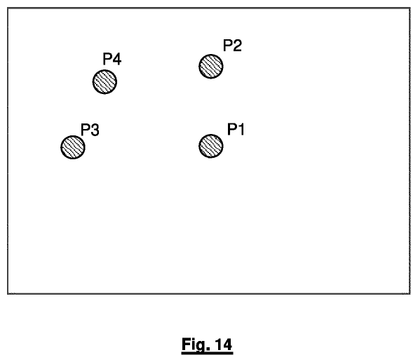

In another embodiment a combination of the offsets of FIGS. 2, 3 and 12, 13 could be used. This would result in the mirrors being both tilted and rotated. The second interaction point with the beamsplitter is both shifted sideways and upwards from the first interaction point where the input beam is incident on the beamsplitter. The various possible interaction points are compared in the schematic diagram of FIG. 14. The rectangle of FIG. 14 represents the area of the beamsplitter, such as viewed from the input beam or optical source. If the input beam is circular then it may be incident centrally on the beamsplitter at P1. For the embodiment of FIGS. 2 and 3 the second interaction point with the beamsplitter is shifted upwards to P2. For the embodiment of FIGS. 12 and 13 the second interaction point is to the side of the first interaction point such as at P3. In this further embodiment the second interaction P4 is both to the side and higher than the first interaction point. Although points P2-P4 are shown in FIG. 14 as shifted to the left side and/or shifted upwards in comparison to P1, they may also be shifted to the right side and/or shifted downwards. By offsetting the second interaction point by tilting and rotating the mirrors, it may be easier to space the second interaction point from the first so as to have enough space to include the second detector without blocking the input beam. Other considerations such as components, detectors, analysis techniques etc. may be applied equally to this embodiment as to the preceding embodiments.

We have previously discussed that the two detectors may have different operating wavelengths to enable a broadband spectrometer to be produced. In a further embodiment the detectors may be substantially the same. The optical arrangement may include any of the offsets shown in FIG. 2, 3, 12, 13 or 14. The use of two detectors which are substantially the same or covering the same wavelength range allows more of the signal to be collected increasing the signal-to-noise ratio, as compared to the prior art device having a single detector. By combining the data from two detectors the signal level may be doubled. To use the data to produce an increased signal-to-noise ratio, the interferograms from each of the two detectors are first used to produce respective spectra. The two spectra may then be combined by averaging the spectra resulting in the increase in signal-to-noise ratio. The signal-to-noise ratio may be increased by 41% using two identical detector arrays.

For two detectors arrays that are not identical there are other possibilities for performance improvement. If one of the detector arrays has a higher pixel density (smaller pixels) this detector will provide better resolution. The detector with lower pixel density (larger pixels) will have better signal-to-noise ratio. This assumes the detector array with smaller pixels is larger or has more pixels than the other pixel array. It is also assumed that the optical path difference, OPD, can be adjusted to set the fringe size optimally.

A modification to the embodiment having two identical detector arrays is to add polarisers in front of the detectors. The polarisers would be arranged such that the polariser in front of the first detector would be orthogonal to the polariser in front of the second detector. In this way the first detector would generate an interferogram for a first polarisation and the second detector would generate an interferogram for a second polarisation orthogonal to the first. Hence, wavelength and polarisation information may be obtained on the input light. This could be used to detect changes in polarisation caused by the presence of certain molecules. For example, chirality in molecules such as biomaterials may be measured in this way. Measurements of chirality may be used as a measurement of biodiversity in a region, such as a region of rainforest. If high levels of biodiversity are found then the region can be protected.

Another arrangement based on interferometers described herein that use two identical detector arrays is to include a sample cell and reference cell in the optical paths. The sample and reference cell are placed in each of the beams paths before the detector arrays and the light transmitted through the cells will differ depending on the contents of the reference cell and the sample. In this way a measurement of the absorption spectrum of a sample may be determined and may be measured in real-time.

In a further embodiment a diffraction grating may be provided in front of one of the detectors. This will provide increased resolution at that detector by spreading out different spectral components of light further across the detector. Hence, the first detector may have the grating in front of it and provide a high resolution at a narrow spectral bandwidth, whereas the second detector may provide a more conventional bandwidth of operation.

Alternatively, a second grating different to the first may be provided in front of the second detector to provide detection of two wavelength regions of high resolution.

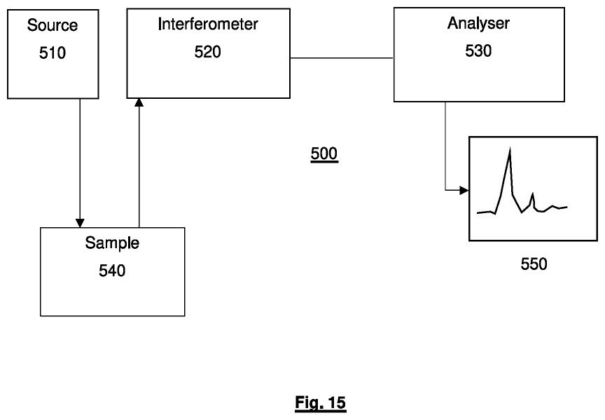

FIG. 15 is a schematic diagram of a spectrometer incorporating the interferometer according to embodiments of the present invention. The spectrometer 500 comprises a light source 510 such as a broadband light source or other source emitting in the wavelengths of interest. The light from the source may directed through or at a sample 540. The sample may absorb, emit or otherwise change the light from the source. For example, the light may have its polarisation changed at a particular wavelength or wavelength range. The sample may be incident at close range to the source or at a distance from the source. For example, the spectrometer may have a chamber for receiving the sample and directing source light at the sample. Alternatively, the sample may be external to the spectrometer. The spectrometer may be a hand-held device and the source may be directed at the sample. The sample may be a long distance from the sample and a collimated or laser beam of light is directed at the sample. The light, having interacted with the sample, is then directed to the interferometer. In another alternative the light may be generated elsewhere and the interferometer is used to characterize the light. In such a case the external light needs to be collimated before entry into the interferometer. This may be by use of an integrating sphere and/or a spatial filter.

The interferometer outputs signals from the two detector arrays and these signals are processed by analyser 530. Analyser 530 may perform various calculations described herein, including performing a Fourier transform of interferogram data from the interferometer. The spectrometer may include a display 440 for displaying the spectral data. Alternatively, the spectrometer may output the spectral data in other ways such as in a data file. The analyser comprises a processor and a memory for performing the analysis. In embodiments the spectrometer may comprise the source 510, the interferometer 520 and the analyser 530 and these may all be in a single housing.

The spectrometer and interferometer described herein has a broad range of applications, including: water analysis, measuring biodiversity, plastics analysis such as for recycling through measuring absorption and/or reflection of incident light, pharmaceuticals etc. SWIR may be used in pharmaceuticals or, for example, to measure moisture content in make-up. Another application is in soil analysis which requires a broad spectral range. Spectral features showing the presence of microplastics may occur in the infrared whereas the properties of soil are generally measured using visible light.

The person skilled in the art will readily appreciate that various modifications and alterations may be made to the above described interferometer and spectrometer without departing from the scope of the appended claims. For example, different mirrors, detectors or beamsplitter may be used. Different wavelengths may be measured and the signal from the second detector may be used for different analyses. Adjustments to the optical arrangement may also be made without departing from the scope of the present invention, as defined by the appended claims.

1. An interferometer comprising:
a beamsplitter arranged to divide an input beam into first and second beams;
path differencing optics arranged to direct the first and second beams in opposite directions around a cyclic path and back to the beamsplitter, wherein the beamsplitter is arranged to divide, on return to the beamsplitter, the first and second beams each into transmitted and reflected portions;
a first detector array arranged to detect a first interference pattern generated from the transmitted portion of the first beam and the reflected portion of the second beam;
wherein one or more components of the path differencing optics are tilted to direct the first and second beams to be incident on the beamsplitter spatially offset, or spatially diverging, from an incidence position of the input beam on the beamsplitter; and
a second detector array arranged to detect a second interference pattern generated from the reflected portion of the first beam and the transmitted portion of the second beam.

2. The interferometer of claim 1, wherein the path differencing optics comprise at least two mirrors or mirror regions.

3. The interferometer of claim 2, wherein the two mirrors or mirror regions comprise two curved mirrors arranged to provide convergence to the first and second beams towards the first and second detector arrays.

4. The interferometer of claim 3, wherein the two mirrors or mirror regions comprise two cylindrically curved mirrors.

5. The interferometer of claim 3, wherein the beamsplitter and the two mirrors are arranged in an optical plane, and the mirrors are tilted to direct the first and second beams out of the optical plane.

6. The interferometer of claim 5, wherein the two mirrors are tilted to direct the beams arriving at them away from the optical plane to a first side of the optical plane.

7. The interferometer of claim 1, wherein the beamsplitter and path differencing optics are arranged in an optical plane, and the path differencing optics are arranged to direct the first and second beams out of the optical plane to a first side of the optical plane.

8. The interferometer of claim 5, wherein the first and second detector arrays are arranged offset from the optical plane, the first and second detector arrays offset to the same side of the optical plane.

9. The interferometer of claim 5, wherein the first beam comprises a portion of the input beam transmitted by the beamsplitter and the second beam comprises a portion of the input beam reflected by the beamsplitter, and wherein the path differencing optics and the beamsplitter are arranged to direct the reflected portion of the first beam and the transmitted portion of the second beam out of the optical plane and offset from the input beam.

10. The interferometer of claim 9, wherein the path differencing optics and the beamsplitter are arranged to direct the reflected portion of the first beam and the transmitted portion of the second beam to generate the second interference pattern at the second detector array positioned offset from the input beam and the optical plane.

11. The interferometer of claim 1, wherein the beamsplitter and path differencing optics are arranged in an optical plane, and the path differencing optics are arranged to direct the first and second beams offset from, or diverging from, the incidence position of the input beam at the beamsplitter, wherein the offset or diverging comprises an offset or divergence in the out-of-plane direction and the in-plane direction.

12. The interferometer of claim 1, wherein the first and second detectors are arranged transversely to each other.

13. The interferometer of claim 1, wherein the optical path distance from the beamsplitter to the first detector array is substantially the same as the optical path distance from the beamsplitter to the second detector array.

14. The interferometer of claim 1, wherein the beamsplitter is adapted to divide the input beam such that the first and second beams have substantially equal intensity.

15. The interferometer of claim 1, wherein the first and second detector arrays are configured to provide simultaneous detection of the first and second interference patterns respectively.

16. The interferometer of claim 1, wherein the sensing elements of the first and second detector arrays are made of different materials or are of different types, and the first and second detector arrays have different operating wavelengths.

17. The interferometer of claim 16, wherein the first detector array and second detector have different operating wavelengths, the first detector array having an operating wavelength range w1 to w2 and the second detector array having an operating range w2 to w3, such that the combined operating wavelength range of the first and second detector arrays is greater than the operating wavelength range of the first or second detector arrays alone.

18. The interferometer of claim 16, wherein one of the first and second detector arrays is a visible light detector and the other of the first and second detector arrays is a short-wave infrared, SWIR, detector.

19. The interferometer of claim 16, wherein one of the first and second detector arrays is a visible light detector and the other of the first and second detector arrays is an ultraviolet detector.

20. The interferometer of claim 16, wherein the first detector is at least one of: a visible light detector, a short-wave infrared detector, an ultraviolet detector, a mid-wavelength infrared detector, a long-wavelength infrared detector, a far infrared detector, a near infrared detector, and an x-ray detector, and the second detector is a different at least one of: a visible light detector, a short-wave infrared detector, an ultraviolet detector, a mid-wavelength infrared detector, a long-wavelength infrared detector, a far infrared detector, a near infrared detector, and an x-ray detector.

21. The interferometer of claim 1, wherein one of the first and second detector arrays has smaller sensing elements than the other of the first and second detector arrays.

22. The interferometer of claim 1, wherein the first detector and second detector are the same at least one of: a visible light detector, a short-wave infrared detector, an ultraviolet detector, a mid-wavelength infrared detector, a long-wavelength infrared detector, a far infrared detector, a near infrared detector, and an x-ray detector.

23. The interferometer of claim 1, further comprising a laser source and a mirror, the mirror arranged to direct a laser beam from the laser source via the beamsplitter and path differencing optics to produce interference patterns on the first and second detector arrays.

24. The interferometer of claim 1, further comprising a first polariser arranged in the beam path between the beamsplitter and first detector array and a second polariser arranged in the beam path between the beamsplitter and second detector array, the first and second polarisers being crossed polarisers arranged to transmit orthogonal polarisations of light.

25. The interferometer of claim 1, further comprising a diffraction grating arranged in the beam path between the beamsplitter and the first detector array or second detector array, the diffraction grating arranged to provide diffraction pattern on the respective first detector array or second detector array.

26. An interferometer comprising:
a beamsplitter arranged to divide an input beam into first and second beams;
path differencing optics arranged to direct the first and second beams in opposite directions around a cyclic path and back to the beamsplitter, wherein the beamsplitter is arranged to divide, on return to the beamsplitter, the first and second beams each into transmitted and reflected portions;
a first detector array arranged to detect a first interference pattern generated from the transmitted portion of the first beam and the reflected portion of the second beam;
wherein one or more components of the path differencing optics are arranged to keep the first and second beams in the optical plane and direct the first and second beams to be incident on the beamsplitter spatially offset, or spatially diverging, from an incidence position of the input beam on the beamsplitter; and
a second detector array arranged to detect a second interference pattern generated from the reflected portion of the first beam and the transmitted portion of the second beam.

27. The interferometer of claim 26, wherein the second detector array is adjacent to the path of the input beam.

28. A spectrometer comprising an interferometer comprising:
a beamsplitter arranged to divide an input beam into first and second beams;
path differencing optics arranged to direct the first and second beams in opposite directions around a cyclic path and back to the beamsplitter, wherein the beamsplitter is arranged to divide, on return to the beamsplitter, the first and second beams each into transmitted and reflected portions;
a first detector array arranged to detect a first interference pattern generated from the transmitted portion of the first beam and the reflected portion of the second beam, wherein one or more components of the path differencing optics are tilted to direct the first and second beams to be incident on the beamsplitter spatially offset, or spatially diverging, from an incidence position of the input beam on the beamsplitter;
a second detector array arranged to detect a second interference pattern generated from the reflected portion of the first beam and the transmitted portion of the second beam; and
an analyser configured to receive signals or data from the first and second detector arrays representing the first and second interference patterns, the analyser configured to generate a spectrum showing the relative spectral contents of the input beam.

29. The spectrometer of claim 28, wherein the analyser is configured to Fourier transform the signals or data received from the first and second detector arrays representing the first and second interference patterns to produce the spectrum.

30. The spectrometer of claim 28, wherein the analyser is configured to use a windowing function on the signals or data received from the first and second detector arrays representing the first and second interference patterns to process the data or signals prior to performing the Fourier transform.
